(19) United States
(12) Patent Application Publication
(10) Pub. No.: US 2026/0232140 A1
(43) Pub. Date: Aug. 13, 2026

(54) BASE UNIT FOR A FOOD PROCESSOR AND INTERCHANGEABLE ACCESSORY CONTAINER

(71) Applicant: Vorwerk & Co. Interholding GmbH, Wuppertal (DE)

(72) Inventors: Nils Beckmann, Remscheid (DE); Christian Bayard, Witten (DE); Philipp Ingenlath, Schwelm (DE); Giuseppe Sasunna, Solingen (DE); Volker Wahle, Hamminkeln (DE); Daniel Bambeck, Essen (DE); Helmut Schönhoff, Remscheid (DE); Sigurd Wojke, Sprockhövel (DE)

(21) Appl. No.: 19/540,303

(22) Filed: Feb. 13, 2026

(30) Foreign Application Priority Data
Feb. 13, 2025 (EP) 25157702.9

(51) Int. Cl. A47J 43/07; A47J 43/046; H01R 12/71; H01R 13/04; H01R 13/11; H01R 13/187; H01R 13/502; H01R 13/627

(52) U.S. Cl. CPC A47J 43/0716; A47J 43/046; H01R 12/716; H01R 13/04; H01R 13/113; H01R 13/187; H01R 13/502; H01R 13/6275

(57) ABSTRACT

The present disclosure relates to a base unit (1) for a food processor for preparing a food (20), wherein the base unit (1) comprises a control (2) and a receiving device (3) for receiving and electrically connecting an interchangeable accessory container (10), wherein the receiving device (3) comprises at least one receiving-side plug-in connection unit (4) for the electrical connection. The receiving-side plug-in connection unit (4) is movable in the mounted state in such a way that at least a part of the receiving-side plug-in connection unit (4) can move with an accessory container (10) when the accessory container (10) is electrically connected to the receiving device (3) via the receiving-side plug-in connection unit (4). A particularly reliable transmission of data signals between the control (2) of the base unit (1) and the container accessory (10) can thus be made possible. The present disclosure also relates to a corresponding accessory container.

### PRIORITY CLAIM

This application claims priority to European Patent Application No. 25157702.9, filed Feb. 13, 2025, which is hereby incorporated in its entirety herein.

### FIELD OF THE DISCLOSURE

The present disclosure relates to a base unit for a food processor for preparing a food, wherein the base unit comprises a control and a receiving device for receiving and electrically connecting an interchangeable accessory container, wherein the receiving device comprises at least one receiving-side plug-in connection unit for the electrical connection. The present disclosure further relates to the interchangeable accessory container.

### BACKGROUND

Examples of such base units and accessory containers can be found in the prior art in cooking mixers, the base units of which have a socket-like plug-in contact as the receiving-side plug-in connection unit, which is realized as a resilient clip. Two contact arms are inclined towards each other to form a gap into which a contact pin of an accessory-side plug-in connection unit can be inserted, causing the two contact arms to be elastically displaced so that the gap corresponds to the diameter of the inserted contact pin. An accessory container with such contact pins is disclosed in the publication EP3292806B1. The two contact arms clamp the contact pin and produce an electrical connection to the contact pin. In the mounted state, the two arms are arranged in a housing part in such a way that, apart from normal manufacturing and assembly tolerances, no movement of the socket-type plug-in contact or a part thereof is possible or provided, but only a resilient, elastic deflection of the two contact arms when the contact pin of an accessory-side plug-in connection unit of a container accessory, such as a pot with heating element and mixing blade, is inserted and removed. In total, base units known from the prior art have five such receiving-side plug-in connection units, of which two plug-in connection units are provided for the power supply of the heating element, two plug-in connection units are provided for measuring a temperature-dependent resistance for simple analogue temperature determination of the container accessory and an earthing contact is provided. Due to the increase in electronics, sensors and intelligence in the field of semi-automated food preparation, the requirements for signal transmission through the plug-in connections are also increasing.

### SUMMARY

The aforementioned features known from the prior art can be combined individually or in any combination with one of the objects and configurations of the present disclosure described below.

It is the task of the present disclosure to provide a further developed base unit together with an accessory container.

In a first aspect of the present disclosure, a base unit for a food processor for preparing a food serves to solve the task, wherein the base unit comprises a control and a receiving device for receiving and electrically connecting an interchangeable accessory container. The receiving device comprises at least one receiving-side plug-in connection unit for the electrical connection, i.e., for the electrical connection of an interchangeable accessory container. In the mounted state, the receiving-side plug-in connection unit is at least partially movable, such that at least a part of the receiving-side plug-in connection unit can move with an accessory container, in particular when the accessory container vibrates during the preparation of food, when it (accessory container) is electrically connected to the receiving device via the receiving-side plug-in connection unit. This enables particularly reliable transmission of data signals between the control of the food processor and the container accessory.

The receiving-side plug-in connection unit of the known base units has no part that can move along with an accessory container in the mounted state when the accessory container is electrically connected to the receiving device via the receiving-side plug-in connection unit.

The present disclosure is based on the idea that wear due to frictional contact (friction on the contact surface of a contact plug element and a contact socket element) can lead to minor wear-related defects on the surfaces of the contacts over time, which can affect the conduction of data signals. However, because the receiving-side plug-in connection unit remains in the receiving device when an accessory container is removed or replaced, friction frequently occurs on the surfaces of the contacts each time the accessory container is removed or replaced, even with the base unit according to the present disclosure. However, it was recognized that a receiving-side plug-in connection unit which is at least partially movable in the mounted state and which can move at least in part with a connected accessory container, in particular to the extent of axial and/or radial play, can limit the friction and wear resulting from movements of the accessory container due to the preparation of a food to a level such that a data signal can be transmitted particularly reliably over a provided service life of several years of a base unit for a food processor with daily use.

An interchangeable accessory container is an accessory with a container for food preparation. In addition to the container, the accessory container may also comprise a lid. The accessory container may further comprise one or more functional components, such as a heating element, a holder for a tool, a mixing tool and/or a cutting tool. In one embodiment, the lid may provide a functional component, for example in the form of a cutting tool, in particular to extend the function or functions of the accessory container, which may not include a functional component or may include one or more functional components. In one embodiment of the accessory container, the accessory container comprises a container and a cutting tool located in the lid. The accessory container may comprise one or more sensors for measuring temperature and/or for recognizing a lid or a lid state. The accessory container may comprise a signal processing unit for processing sensor data from the at least one sensor and/or for communication, in particular with the control of the base unit, preferably by exchanging digital signals.

An interchangeable accessory container is not part of the base unit. The base unit itself comprises the receiving device for receiving and electrically connecting an accessory container. Several identical or several different accessory containers can exist separately from the base unit, which can then be connected to the receiving device, removed from the receiving device and/or exchanged as required by the user. In particular, the base unit comprises an electric motor for mechanically driving at least one functional component of the accessory container, preferably the mixing and/or cutting tool, preferably via a mechanical interface of the receiving device.

Electrical connection means an electrical connection for transmitting data signals and/or for electrical power supply. Receiving means that an accessory container can be arranged on (held by) the receiving device and/or mechanically connected to the receiving device in such a way that food can be prepared in the accessory container. An accessory container that is not received by the receiving device could change its position in an unplanned manner during the preparation of a food, so that trouble-free preparation of the food would not be ensured. In particular, the receiving device provides a guiding and/or locking device for receiving the accessory container. Food can also be prepared without locking the accessory container to the base unit.

The control may comprise several, locally separate control units in the base unit, which are connected to each other by cable or wirelessly. It is also possible in principle for part of the control to be realized by an external computing unit, such as a smartphone or cloud computer, which communicates wirelessly with a part of the control integrated in the base unit.

Several plug-in connection units can together form a plug-in connection module. In one embodiment, such a plug-in connection module has both the at least one receiving-side plug-in connection unit, which is at least partially movable in the mounted state, such that it can move at least in part with a connected accessory container, and at least one plug-in connection unit with a different design, which is not at least partially movable in the mounted state, such that at least part of it could move with a connected accessory container, i.e. similar to the base units described at the beginning, which also include, for example, the TM5 and TM6 of the applicant. The at least one plug-in connection unit with a different design is (in each case) realized in particular by a spring-loaded clip. Preferably, two contact arms are inclined towards each other in order to form a gap into which a contact pin of an accessory-side plug-in connection unit can be inserted, whereby the two contact arms are elastically displaced so that the gap corresponds to the diameter of the inserted contact pin. Preferably, two different versions of resilient clamps are placed, of which a first version (preferably for earthing) is dimensioned for a larger contact pin diameter than a second version, which is preferably arranged adjacent to the first version in the plug—in connection module. In particular, the two contact arms clamp the contact pin in the connected state and produce an electrical connection to the contact pin. In the mounted state-apart from normal manufacturing and assembly tolerances—the two arms do not allow any movement of the socket-like plug contact in the form of the spring-loaded clamp for moving a connected accessory container, but only a spring-loaded, elastic deflection of the two contact arms when inserting and removing the contact pin of an accessory-side plug-in connection unit of a container accessory, such as a pot with heating element and mixing blade.

In one configuration, the at least one receiving-side plug-in connection unit has a contact socket element that can move with an accessory container when the accessory container is electrically connected to the receiving device via the receiving-side plug-in connection unit, or a contact plug element that can move with an accessory container when the accessory container is electrically connected to the receiving device via the receiving-side plug-in connection unit. A particularly reliable plug-in contact connection can be achieved in this way. The contact socket element and/or the contact plug element is therefore the part or therefore belongs to the part of the receiving-side plug-in connection unit that can move with an accessory container in the mounted state when it (accessory container) is electrically connected to the receiving device via the receiving-side plug-in connection unit.

A plug-in connection unit with a contact socket element can also be referred to as a female plug-in connection unit. A plug-in connection unit with a contact plug element can also be referred to as a male plug-in connection unit. In one embodiment, if the receiving-side plug-in connection unit has a contact socket element, the (female) receiving-side plug-in connection unit is provided for connecting to a contact plug element of a (male) accessory-side plug-in connection unit. In an alternative configuration, if the receiving-side plug-in connection unit has a contact plug element, the (male) receiving-side plug-in connection unit is provided for connecting to a contact socket element of a (female) accessory-side plug-in connection unit.

In a further development, there is a receiving-side plug-in connection module and/or an accessory-side plug-in connection module. In particular, a receiving-side plug-in connection module has exclusively male or female accessory-side plug-in connection units, which can be designed differently, e.g., in the form of contact socket elements and socket-like plug contacts or contact plug elements and contact pins. In particular, an accessory-side plug-in connection module has exclusively female or male accessory-side plug-in connection units.

In one configuration, the receiving-side plug-in connection unit is such that the at least one part of the receiving-side plug-in connection unit, in particular the contact plug element or the contact socket element, is movable, and that the axial mobility of the at least one part of the receiving-side plug-in connection unit is limited by an axial play, so that the at least one part of the receiving-side plug-in connection unit can move axially with an accessory container to the extent of the axial play when the accessory container is electrically connected to the receiving device via the receiving-side plug-in connection unit. This enables particularly reliable transmission of data signals.

The axial play indicates the maximum range of movement in the axial direction, i.e., the largest possible distance that can be travelled in the axial direction by the movement. In one embodiment, in which the contact socket element corresponds to the movable part of the receiving-side plug-in connection unit, for example, there is an axial play of 0.5 mm if an installation space extends 0.5 mm further in the axial direction than the axial length of the contact socket element, which can move axially freely in the installation space when the receiving-side plug-in connection unit is mounted and connected.

In one configuration, the axial play is at least 0.4 mm, in particular when the movable part corresponds to the contact socket element. It has been recognized that this lower limit of the play is already sufficient to reliably transmit data signals over the provided service life of the base unit. In particular, interference due to axial vibrations is reduced or avoided.

In one configuration, the axial play is at most 1 mm. This enables particularly reliable data transmission over the service life. Increased wear caused by connecting, removing or changing the accessory container can thus be prevented.

In one configuration, the receiving-side plug-in connection unit is designed such that, in the connected state, the axial play is greater than a radial play, there is no radial play and/or radial movement of at least part of the receiving-side plug-in connection unit is only possible by elastic deformation of the movable part of the receiving-side plug-in connection unit, in particular the contact socket element. A reliable plug-in connection with not too much and not too little pressure on the plug-in connection can thus be maintained for the entire service life. For example, the contact plug element can thus be easily inserted into and removed from the contact socket element manually by the user, wherein reliable data signal transmission is possible at the same time.

In one configuration, the axial play in the connected state is greater than the radial play and/or the axial play in the non-connected state is less than the radial play. This enables particularly reliable data signal transmission. In one embodiment, the radial play of the contact socket element in the mounted state is at least 0.3 mm and/or at most 0.5 mm if there is no connected state.

In one configuration, the base unit is configured such that an analogue or digital signal is transmitted via the receiving-side plug-in connection unit in the connected state, in particular between the control of the base station with the signal processing unit of the accessory container. In an alternative or supplementary configuration, the base unit is configured such that a connected accessory container can be supplied with electrical energy, in particular with mains voltage. The number of receiving-side plug-in connection units can thus be reduced. Preferably, the digital signal data exchange and the power supply is carried out by means of two receiving-side plug-in connection units, which are in particular arranged directly next to each other in the receiving-side plug-in connection module. Preferably, communication takes place bidirectionally via half-duplex, via PLC (power line principle) and/or via current pulses (and the associated fluctuation of the supply voltage) in each case via the same receiving-side plug-in connection units.

In one embodiment, transmission of digital signal data is provided by the electrical connection. The provided mobility in the mounted and connected state enables reliable digital signal data transmission over the service life of an averagely operated base unit. This enables the accessory container and/or a state of the accessory container to be recognized by means of the digital signal data transmitted by the accessory container. In one embodiment, the control of the base unit is configured such that it can adapt the food preparation process to the accessory container and its condition, e.g., by limiting the speed of a mixing or cutting tool if a container accessory has no lid or a lid is not closed. Due to the higher manufacturing costs and the high susceptibility to faults, digital data connections have so far been rejected in the areas of a base unit with large vibrations during cooking due to heating, mixing and/or stirring, which occur particularly at the interface to the accessory container and the receiving device. However, it has been recognized that the advantages of using a digital interface between the accessory container and the receiving device for recognizing the accessory container and its status more than compensate for the additional cost of a correspondingly more complex production.

In one embodiment, the receiving-side plug-in connection unit is configured such that the contact socket element is movably guided in an axial direction in such a way that the contact socket element can move axially with a contact plug element in the connected state. This enables particularly reliable signal data transmission, including digital data in addition to the known resistance-based temperature determination or analogue signals.

In one configuration, the receiving-side plug-in connection unit is configured such that when an accessory container (with a contact plug element or a contact socket element) is connected to the receiving device (with a contact socket element or a contact plug element), the contact plug element is inserted axially into the contact socket element. In an alternative or supplementary configuration, the contact socket element expands elastically in a radial direction, which is orientated transversely to the axial direction, in order to accommodate (receive) the contact plug element and produce a touching contact for the electrical connection of the base unit to an accessory container. This enables a particularly reliable, detachable electrical connection.

Axial or axial direction refers throughout the present disclosure to the orientation (of an imaginary axis) along which the connection of an accessory container to the base unit is or can be made by plugging it in. Radial or radial direction means oriented transversely to the axial direction and/or away from an (imaginary) center axis (if present).

In one configuration, the receiving-side plug-in connection unit has the contact socket element and the contact socket element has a C-shape when viewed in cross-section (i.e., when viewed from above in the axial direction of the cross-section). This enables a particularly reliable, elastic radial expansion for the electrical connection with an inserted contact plug element.

In an alternative or supplementary configuration, the receiving-side plug-in connection unit has the contact socket element and a hollow body mounted therein, wherein the contact socket element is guided axially in the axially extending hollow body. A reliable plug connection with not too much and not too little pressure on the plug connection can thus be maintained for the entire service life. For example, the contact plug element can thus be easily inserted into and removed from the contact socket element manually by the user, wherein reliable data signal transmission is possible at the same time. When the contact plug element is inserted into the contact socket element, the radial elastic expansion of the contact socket element is limited by the hollow body, which therefore forms a radial stop.

In one configuration, the receiving-side plug-in connection unit has the contact socket element, wherein the contact socket element has an axial through-opening with a narrowed region. An elastic, radial displacement and widening of the narrowed region when producing the touching contact can thus be achieved for a reliable electrical connection. An axial through-opening may have a circumferentially closed contour or an open contour, e.g., with a C-shaped cross-section. In other words, a contact socket element with a C-shaped cross-section also has a through-opening. In one embodiment, the narrowed area is concave in the axial direction.

In one embodiment, the contact socket element is shaped like a cylinder, preferably with an axial slot to create a C-shaped cross-section and/or with an hourglass-like shape when viewed in the axial direction. Preferably, the narrowed region is not centered when viewed in the axial extension of the contact socket element, but is located closer to the upper end than to the lower end of the contact socket element, which is connected to the cable. Preferably, the narrowed region is greater than one third of the length of the cylindrical part and/or the part with the C-shaped cross-section of the contact socket element.

In one embodiment, the contact socket element is shaped like a cylinder, in particular with a constant diameter over the predominant axial length. Preferably, the cylindrically shaped contact socket element has a uniform, constant diameter with the exception of the narrowed region. Preferably, the narrowed region is axially adjacent to the cylindrical shape with the uniform, constant diameter of the contact socket element when viewed in the axial direction.

In an alternative or supplementary configuration, the contact socket element of the receiving-side plug-in connection unit is formed from a plurality of elastically deformable struts at least in an axial section, preferably in a basket-like or lamellar manner. In one embodiment, the struts are wire-shaped and/or bent with a winding. Elastic, radial displacement and widening when producing the touching contact can thus be achieved for a reliable electrical connection. In one embodiment, the struts are produced by stamping from a sheet metal, all extend axially parallel and/or are distributed in the circumferential direction (i.e., distributed and spaced apart). In one embodiment, the narrowed region extends axially within the axial section formed by the plurality of elastically deformable struts.

In one embodiment, the narrowed region and the axial section are congruent. Preferably, the narrowed region extends over the entire axial section and is formed by the webs, which can be lamellae in particular, so that when the contact plug element is connected, the webs (or lamellae) are elastically deformed radially outwards, so that the touching contact is made between the elastically deformed webs (or lamellae) and the contact plug element.

In one embodiment, the contact socket element and/or its webs are produced from sheet metal and/or a material thickness of at least 0.1 mm, preferably at least 0.15 mm and/or at most 0.3 mm, preferably at most 0.2 mm is provided. Optimum elastic deformation for reliable contacting, which is also suitable for fault-free or fault-resistant transmission of digital signal data, can thus be made possible over the service life. In particular, the embodiment prevents a noticeable increase in contact resistance over the service life.

In one embodiment, which can be applied to all preceding and subsequent embodiments and configurations, the contact plug element is shaped like a pin and/or is a contact pin. In one embodiment, a contact pin is an elongated, cylindrical pin preferably made of solid material and/or having a rounded free end. Preferably, the diameter of the pin-shaped contact plug element is at least 2.5 mm and/or at most 5 mm. In one embodiment of the contact plug element, which is provided for the transmission of digital signal data, the diameter is at least 3.5 mm and/or at most 4.5 mm.

In one embodiment, in particular in which a contact plug element is not provided for the transmission of digital signal data but exclusively for power supply, the contact plug element can have a first axial section with a larger diameter and a second section adjacent thereto with a smaller diameter compared to the first axial section. Preferably, the second axial section ends with a free end of the contact plug element. In one alternative or complementary embodiment, the contact plug element can have a two-edge cross-sectional shape. In particular, the diameter of the first axial section is at least 3.5 mm and/or at most 4.5 mm. Preferably, the diameter of the second axial section is at least 1 mm and/or at most 2 mm less than the diameter of the first axial section. Preferably, the diameter of the second axial section is at least 2.5 mm and/or at most 3 mm. By providing different diameters and a smaller diameter for such contact plug elements without digital data signal transmission function, the mating force of a plug-in connection module with several plug-in connection units can be reduced. In one embodiment, a plurality of the contact plug elements described above are comprised in an accessory-side plug-in connection module of an accessory container.

In one configuration, in which the receiving-side plug-in connection unit has the contact socket element, a cable is attached to the contact socket element, in particular directly. Direct data signal transmission to the cable can thus be enabled. In an alternative or supplementary configuration, the contact socket element of the receiving-side plug-in connection unit has a resilient fastening device for the cable. It can thus be achieved that forces caused by relative movements between the accessory container and the base unit can be absorbed by the resilient fastening device, so that the fastening of the cable to the contact socket element does not cause or reduce the contact socket element to be held by the cable when it is intended to move with the contact plug element. Relative movements at the touching contact can thus be reduced or avoided. This enables particularly reliable signal data transmission. In one embodiment, the fastening device is realized by crimping and/or the section of the contact socket element that is plastically deformed for crimping is resiliently connected to the remaining part of the contact socket element via a resilient connection of the fastening device.

In one embodiment, it is provided that the hollow body extends longitudinally in the axial direction and that the contact socket element is arranged with radial play in the hollow body when the accessory is not connected to the receiving device.

In one embodiment, it is provided that the contact socket element is radially expanded in the connected state or is radially expanded by the connection to such an extent that the contact socket element has no radial play relative to the hollow body in a cross-sectional plane and/or rests against the hollow body.

In one embodiment, it is provided that the hollow body is cylindrical and/or is a sleeve, preferably made of metal, in particular of electrically conductive metal. Preferably, the hollow body has a material thickness of at least 0.3 mm and/or at most 0.5 mm. In particular, the hollow body has a radial play in an installation space of a housing section, which is only present due to a tolerance-related installation play, e.g., between 0.05 mm and 0.15 mm. This enables tight guidance, but also allows mobility of the hollow body.

In one embodiment, the contact socket element is provided axially movable in a housing section. In particular, the housing section has two preferably ring-like stop surfaces, which limit the axial play for the axial free movement of the contact socket element in the mounted state.

In particular, the ring-like stop surface facing the base unit has a C-shape when viewed in cross-section from above. The fastening unit, in particular at least one arm for plastic deformation for clamping a cable, can protrude radially in this way in order to be guided in the axial gap formed by the C-shape so as not to restrict axial mobility.

In one embodiment, it is provided that the hollow body is mounted in a housing section in such a way that the hollow body is axially movable in the housing section with an axial play of preferably at least 0.1 mm and/or at most 0.2 mm. In one embodiment, the housing section is shaped such that the hollow body is limited in its axial freedom of movement at both axial ends by ring-like stop surfaces of the housing section, which in particular defines the axial play by the axial distance between the two stop surfaces.

In one embodiment, the housing section belongs to the (receptacle-side or accessory-side) plug-in connection unit and/or a housing section is provided for each plug-in connection unit. In one embodiment with a (receptacle-side or accessory-side) plug-in connection module with several plug-in connection units, the housing sections are preferably in one piece and/or can be formed as a whole from an upper housing module part and a lower housing module part, which are preferably produced by injection molding. In particular, the contact socket element is placed in the lower housing module part for assembly, preferably together with or in the hollow body, and (if this has also been done for all other plug-in connection units of the plug-in connection module) the upper housing module part is placed on the lower housing module part from above and connected (preferably by hooking and/or gluing), so that the contact socket element is mounted so that it can move with axial play. One axial stop surface is then formed by the lower housing module part and the other axial stop surface by the upper housing module part. In particular, the cable is already fastened to the contact socket element before this assembly and/or the lower housing module part has an axial gap so that the contact socket element can be inserted up to the stop surface while the fastening unit and/or the cable passes laterally through the gap axially downwards.

In one embodiment, the upper housing module part of a receiving-side plug-in connection module has an axial insertion opening for each receiving-side plug-in connection unit for inserting a respective contact plug element. In particular, the insertion openings are conical. Preferably, a receiving-side plug-in connection unit has a metal plate on the upper side of the upper housing module part for earthing, through which the insertion opening also extends axially so that a contact plug element can be inserted into the insertion opening in order to make a touching contact with the contact socket element located underneath and connected to the metal plate for earthing the accessory container.

In one embodiment, the plug-in openings of receiving-side plug-in connection units, which are provided for the transmission of preferably digital signal data, are circular in cross-section when viewed from above and/or have a narrowest diameter that is so large that the narrowed region of the contact socket element is visible through the plug-in opening when viewed from above. Preferably, the diameter of the insertion opening is larger than the narrowest diameter of the narrowed region and/or smaller than the diameter of the cylindrical part of the contact socket element.

In one embodiment, the plug-in openings of receiving-side plug-in connection units, which are provided exclusively for supplying a connected accessory container with electrical energy (including earthing), e.g., for a heating element of an accessory container, have an elongated hole shape when viewed from above. In one embodiment, a circular plug-in opening is arranged in the center between two plug-in openings with an elongated hole shape in a row and/or the plug-in opening for earthing has a wider elongated hole shape than the other plug-in openings with an elongated hole shape, in particular wider than the elongated hole shape of the neighboring plug-in opening. Mechanical stresses can thus be avoided and the reliability of data transmission can be improved. Preferably, the two ends of the two contact arms inclined towards each other of a resilient clip of a socket-type plug contact, which form a gap between the two ends, are visible from above through the plug-in opening, which in particular has an elongated hole shape. Preferably, the elongated hole extends longitudinally in the direction of an imaginary connecting line between the two ends and/or transversely to the gap. Tensions in the connected state due to the tolerance compensation achieved in this way support a particularly reliable connection by means of plug-in connections, wherein the receiving-side plug-in connection units can transmit signal data, in particular digital signal data, particularly reliably over the entire provided service life of the base unit.

In one embodiment, each of the receiving device of the base unit and/or the accessory container (in particular on its underside) comprises a plug-in connection module with several plug-in connection units. In particular, the plug-in connection units are arranged next to each other in the axial direction to form a row. The row is preferably curved, preferably with a constant radius, which in particular is at least 30 mm and/or at most 40 mm. This enables particularly reliable data transmission. In one embodiment, the angular distance between two neighboring plug-in connection units is 20°.

In one embodiment, a (receiving-side and/or accessory-side) plug-in connection module has a total of two (preferably exactly two) plug-in connection units, which are provided for the transmission of preferably digital signal data and/or for a 12 V (alternatively 5 V or 3.3 V) power supply (in particular DC power supply) for the signal processing unit and/or at least one sensor), a plug-in connection unit for earthing and/or two to three plug-in connection units, which are provided exclusively for power supply, preferably for mains voltage (e.g. 220 V) in addition to the plug-in connection unit for earthing. A particularly reliable data and power supply interface can thus be obtained.

In one embodiment, the accessory container comprises at least one sensor, preferably one or two temperature sensors, one or more Hall sensors and/or a near-field transmitter and near-field receiver. A measurement of the Hall sensor and/or the temperature sensor can thus be transmitted to the control of the food processor by the touching contact between the receiving-side plug-in connection unit and the accessory-side plug-in connection unit.

In one embodiment, the accessory container has a signal processing unit which receives signal data, preferably analogue signal data, from the at least one sensor (preferably wired), processes it and transmits it to the control of the base unit in the form of digital signal data through the touching contact between the receiving-side plug-in connection unit and the accessory-side plug-in connection unit.

A further aspect of the present disclosure relates to an accessory container for the base unit, in particular according to the aspect of the base unit described at the beginning, for preparing a food, wherein the accessory container comprises a signal processing unit and at least one accessory-side plug-in connection unit for electrical connection to the receiving-side plug-in connection unit of the base unit, so that in the connected state at least a part of the accessory-side plug-in connection unit can move with a part of the receiving-side plug-in connection unit when the accessory container is electrically connected to the receiving device. The embodiments, configurations and advantages described above also apply to this aspect of the present disclosure.

A further aspect of the present disclosure relates to a system, in particular a food processor, with a base unit and an accessory container according to the two above-described aspects of the present disclosure for solving the tasks. The above-described configurations, embodiments and advantages also apply to this aspect of the present disclosure.

In the following, exemplary embodiments of the present disclosure are also explained in more detail with reference to figures. Features of the exemplary embodiments can be combined individually or in a plurality with the claimed objects, unless otherwise indicated. The claimed scopes of protection are not limited to the exemplary embodiments.

### BRIEF DESCRIPTION OF THE FIGURES

The figures show:

FIG. 1: Schematic representation of a basic device with a receiving device;

FIG. 2: Schematic representation of an accessory container and a basic device, in particular the basic device of FIG. 1;

FIG. 3: Exploded view of a plug-in connection module with several plug-in connection units with contact socket elements;

FIG. 4: Longitudinal sectional view of a plug-in connection unit with a contact socket element; and

FIG. 5: Schematic representation of an underside of an accessory container with a plug-in connection module with several contact plug elements.

### DETAILED DESCRIPTION

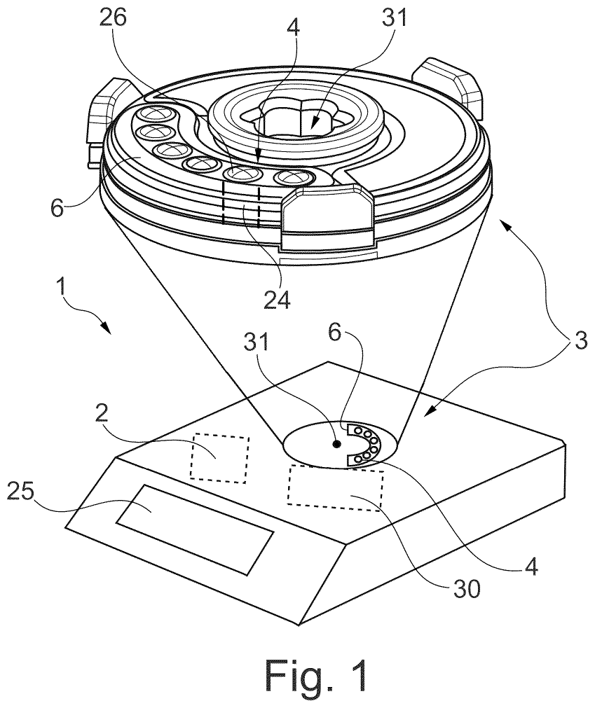

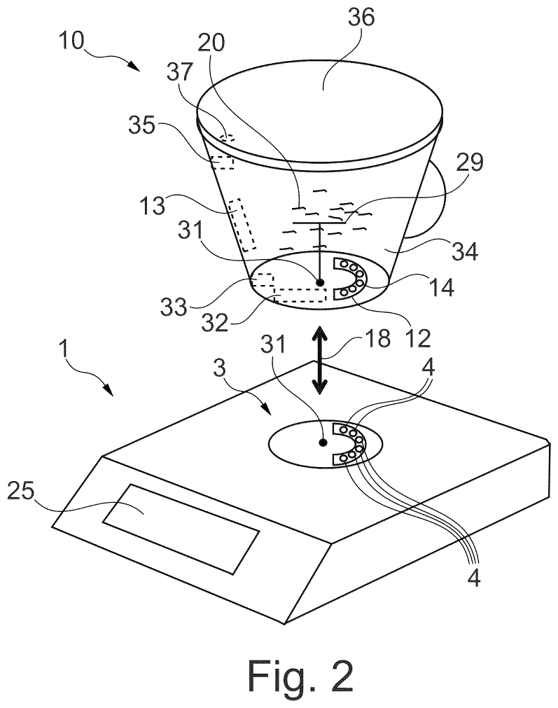

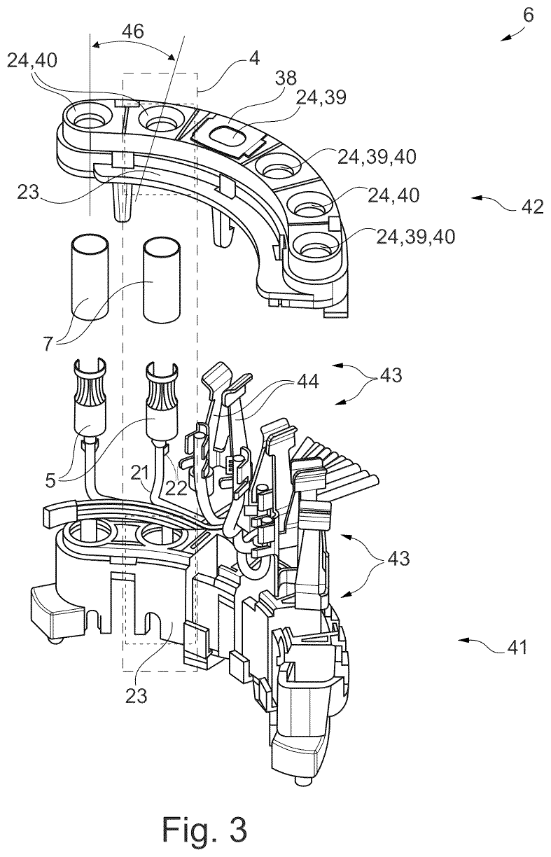

FIG. 1 shows a base unit 1 for a food processor for preparing a food 20, wherein the base unit 1 comprises a control 2, a user interface 25, in particular in the form of a touchscreen display, and a receiving device 3 for receiving and electrically connecting an interchangeable accessory container 10 (see FIG. 2), wherein the receiving device 3 comprises at least one receiving-side plug-in connection unit 4 for electrically connecting an interchangeable accessory container. The receiving-side plug-in connection unit 4 is at least partially movable in the mounted state, such that at least a part of the receiving-side plug-in connection unit (see, for example, the contact socket element 5 in FIG. 3) can move with an accessory container 10 when it is electrically connected to the receiving device 3 via the receiving-side plug-in connection unit 4 and a food 20 is prepared. This will be discussed in more detail later using FIGS. 2 and 3 as examples.

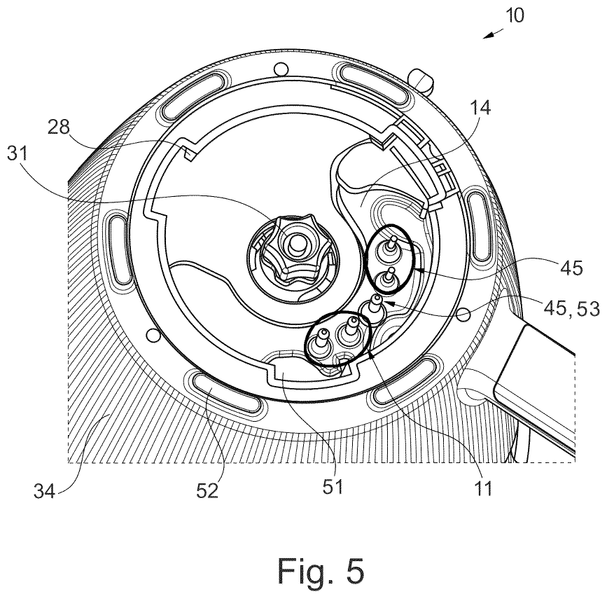

The section in FIG. 1 shows the receiving device 3 in an enlarged manner, which receiving device 3 comprises a receiving-side plug-in connection module 6, in which five—optionally six as shown—plug-in connection units 4, each with an insertion opening 24 (see also FIG. 3), which in the enlarged detailed view of the receiving device 3 are covered by a rubber cover 26 slit in a cross shape over the respective insertion openings 24, which only serves to protect against moisture and foreign bodies in the non-connected state. In FIG. 1, only one of the existing plug-in openings 24 is indicated by dashed lines as representative of the other plug-in connection units 4. In particular, the receiving device 3 has an overall circular and/or disc-like shape, preferably with at least three guiding and/or locking devices 27, which are positioned distributed in the circumferential direction when no accessory container 10 is received, connected or locked by the receiving device 3. For locking, a part of the guiding and locking devices 27 is rotated in the circumferential direction in order to engage with an undercut 28 (see e.g., FIG. 5) of its accessory container 10 and thus lock the accessory container 10 in the received position. However, during food preparation, vibrations often occur which, despite the locking, lead to relative movements between the locked accessory container 10 and the base unit 1. In particular, these vibrations occur during operation (e.g., food movements due to cooking, mixing and/or cutting) and/or are caused by the electric motor 30 that drives the mixing or cutting tool 29 or the mechanical interface 31 for the mixing or cutting tool 29. In addition, relative movements also occur between the connected accessory container 10 and the base unit 1 if the food 20 is prepared without locking by the guiding and/or locking devices 27. This is possible, for example, at low speeds of a mixing or cutting tool 29 and/or the mechanical interface 31 (see FIG. 2), which is driven by an electric motor 30 by means of a mechanical interface 31 for torque transmission for the mixing or cutting tool and/or the tool holder.

By means of the control 2, which can interact with the user via the user interface 25, recipe steps of a digital recipe can be processed together with the user and signal data from sensors (e.g. the temperature sensor 33, which is indicated in FIG. 2) can be analyzed and the electric motor 30 and the power supply for e.g. the heating element 32 (see FIG. 2) can be controlled.

FIG. 2 shows an accessory container 10 for the base unit 1, in particular of FIG. 1, for preparing a food 20 in a container 34 of the accessory container 10, which also comprises a signal processing unit 13 and at least one accessory-side plug-in connection unit 14 for electrical connection to the receiving-side plug-in connection unit 4 of the base unit 1, so that in the connected state at least a part of the accessory-side plug-in connection unit 14 can move with a part of the receiving-side plug-in connection unit 4 when the accessory container 10 is electrically connected to the receiving device 3 and a food 20 is prepared. In one embodiment, the signal processing unit 13 is configured such that the signal processing unit 13 supplies the sensors with electrical energy and also receives their measurement data. The sensors installed in the accessory container include, in particular, one or two temperature sensors 33 for measuring a temperature of the food 20 in the container 34 and/or at least one Hall sensor 35 for detecting a reference body 37, in particular made of metal or in the form of a magnet, which is preferably arranged integrated in a lid 36 of the accessory container 10 in order to be able to determine an open or closed state of the lid 36 and to identify the lid 36. In one embodiment, the signal processing unit 13, which is preferably a microcontroller or chip, transmits a digital signal with identification information of the accessory container, identification information of the lid 36, sensor measurement data, in particular the temperature, and/or status information determined on the basis of sensor data (in particular the open or closed status of the lid 36) to the base unit 1 via the accessory-side plug-in connection units 14 of the plug-in connection module 12. FIG. 2 also shows the mixing and/or cutting tool 29, which can be driven by the base unit 1 via the mechanical interface 31. For connection, the accessory container 10 is placed on the receiving device 3 of the base unit 1 in an axial direction 18, so that the receiving-side and accessory-side plug-in connection units 6, 12 are brought into touching contact, which is explained in more detail below using the exemplary embodiment of FIG. 3 as an example.

FIG. 3 shows a receiving-side or accessory-side plug-in connection module 6, 12, in particular the receiving-side plug-in connection module 6 of FIG. 1 and/or FIG. 2. In the following, the exemplary embodiment of FIG. 3 is explained by way of example for a receiving-side plug-in connection module 6, which has a plurality of receiving-side plug-in connection units 4, one of which is marked with a dashed line as representative of the others. In one embodiment, the plug-in connection units 4 are located next to each other at an angular distance 46 of between 15° and 30°, preferably along an imaginary circular line, preferably with a radius of at least 20 mm and/or at most 50 mm, particularly preferably between 30 and 40 mm. In one embodiment, the receiving-side plug-in connection module 6 has a ring-segment-like shape and/or outer contour. The two plug-in connection units 4 on the left-hand side are at least partially movable in the mounted state in such a way that at least one part of them, in particular the contact socket element 5, can move with a connected accessory container 10 (or with its contact plug element 11, which is shown in FIG. 5, for example). These two plug-in connection units 6 are used to exchange signal data, preferably digital signal data with the signal processing unit 13 of the accessory container 10, and preferably also its power supply, e.g., with a voltage of 12 V (alternatively 3 V or 5 V). In one embodiment, the plug-in connection units 4 for exchanging digital signal data are made of metal (e.g., cold strip) and/or have a silver-copper coating).

Furthermore, the plug-in connection module 6 comprises at least three or four plug-in connection units 4 with a different design, preferably made of a refined cold strip (i.e. coated metal sheet, preferably with a silver alloy coating), which are not at least partially movable in the mounted state such that at least part of them could move with a connected accessory container 10. One of these plug-in connection units 4 of different design is the third plug-in connection unit 4, 12 from the left, which is provided for earthing and/or is additionally covered with a metal plate 38. Each plug-in connection unit 4 of the plug-in connection module 6 has a housing section 23 (indicated in a representative manner by a dashed line in FIG. 3 only for the second plug-in connection unit 4 from the left), which belongs to a preferably one-piece lower housing module part 41, which together with an upper housing module part 42 forms the installation space for the hollow body 7 and the contact socket element 5 guided axially therein, which is connected to a cable 21 by means of a fastening unit 22 (here: for connection by crimping). The upper housing module part 42 has plug-in openings 24 which, with the exception of the plug-in connection unit 4 for earthing, are provided with a conical mouth 40. In particular, the first two plug-in openings 24 from the left are circular, the third plug-in opening 24 from the left is an elongated hole 38, the fourth and/or sixth plug-in opening 24 from the left is also an elongated hole 38, and/or the fifth plug-in opening 24 from the left is circular.

The plug-in connection units 4 with the different design are each realized with a resilient clip 43, which has two contact arms 44 inclined towards each other in order to be able to electrically connect a contact pin 45 (see FIG. 5) in such a way that both contact arms 44 are elastically displaced by a contact pin 45 inserted when an accessory container 10 is connected, so that the contact pin 45 is clamped between the two contact arms 44. In one embodiment, the plug-in openings 24 of the plug-in connection units 4 with the different design, in particular for supplying power to the heating element 32 of a connected accessory container 10, have a smaller diameter than the plug-in openings 11 of the plug-in connection units 4 with the contact socket elements 5 and/or a smaller diameter than the plug-in connection unit 4 for earthing.

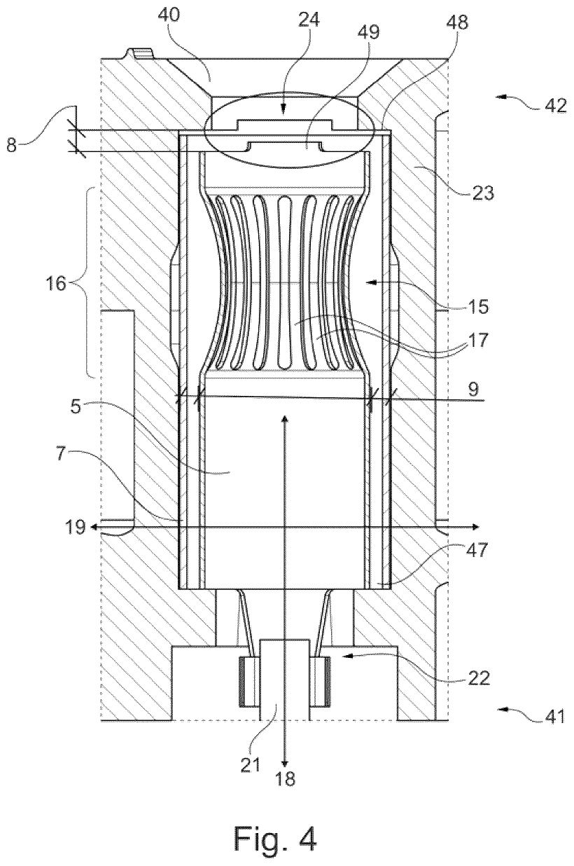

FIG. 4 shows a sectional view through a plug-in connection unit 4, in particular the first or second plug-in connection unit 4 from the left of FIG. 3. The contact socket element 5 is axially limited in the installation space, which is axially limited by the lower housing module part 41 with the lower stop surface 47 and the upper housing module part 42 with the upper stop surface 48, with regard to axial mobility in the extent of the axial play 8 by the aforementioned stop surfaces 47, 48. At the same time, in the non-connected state shown in FIG. 4, the contact socket element 5 has a radial play 9 relative to the hollow body 7, which corresponds to the difference in diameter between the inner diameter of the hollow body 7 and the outer diameter of the contact socket element 5. In particular, the hollow body is a sleeve and/or can move only slightly axially and even less radially. Overall, the mobility of the hollow body 7 is less in all directions in the non-connected state compared to the contact socket element 5. A fastening unit 22, with which the cable 21 is fastened, is located under the lower stop surface 48.

The contact socket element 5 extends in the axial direction with a constant diameter with the exception of a narrowed region 16, which bends concavely inwards, wherein the narrowed region 16 is formed over an axial section by webs 17 distributed over the circumference, in particular in the form of axially extending lamellae. When a contact plug element 11 (see FIG. 5) is inserted into the contact socket element 5 during connection (not shown in FIG. 4), the contact socket element 5 is pressed against the lower stop surface 47 as a result of the friction and (subsequently) the webs 17 are displaced outwards in the radial direction 19 and elastically deformed, while the contact socket element 5 with a C-shaped cross-section (see FIG. 3) is also elastically expanded and widened until the cylindrical lateral surface of the contact socket element 5 radially abuts the inner cylindrical lateral surface of the sleeve-shaped hollow body 7. A touching contact is made between the elastically deformed webs 17 and the contact plug element 11 (not shown in FIG. 4) with a spring-like contact pressure due to both the elastically displaced webs 17 and the elastically expanded outer surface of the contact socket element 5. When food 20 is prepared in this connected state and shocks and vibrations occur, the contact plug element 11 oscillates predominantly axially, in particular in an oscillating manner. Due to the axial play 8, in particular in combination with the low friction between the sleeve-shaped, preferably metallic hollow body 7 and the contact socket element 5, which is also metallic, the contact socket element 5 moves (predominantly) with the contact plug element 11, in particular axially, during these vibrations, which is clamped by the contact socket element 5 in a spring-like manner. Wear is thus avoided or reduced and a particularly reliable transmission of signal data, in particular digital signal data, is enabled over a provided service life of the base unit 1.

In one embodiment, an extension region 49 extends further upwards at an upper end of the contact socket element 5, thereby forming a projection that is shorter than the axial play 8. At the same time, a recess 50 is provided above the axial extension region 49 in the upper housing module part 42, which is shaped in such a way that the extension region 49 can plunge into the recess 50 when the contact socket element 5 is moved upwards and abuts the upper stop surface 48. The extension area 49 and the recess 50 ensure that the contact plug element 11 is held precisely in a fixed rotational position when it is pulled out. Wear can thus be reduced and a particularly reliable transmission of signal data, in particular digital signal data, can be enabled over a provided service life of the base unit 1.

FIG. 5 shows an accessory container 10 with a container 34 from the underside, at the center of which there is a mechanical interface 31 for driving by the electric motor 30 of the base unit 1. The accessory-side plug-in connection module 12 comprises two contact plug elements 11 (highlighted with circles in FIG. 5 for clarification) for transmitting preferably digital signal data and three or four contact pins 45, of which the contact pin 45 arranged next to the contact plug elements 11 is provided for earthing. In one embodiment, the contact plug elements 11 (preferably made of a first brass alloy and/or with a coating of a first other metal alloy), the contact pin 45 for earthing (preferably made of steel) and/or the contact pins 45 for the power supply (preferably made of a second brass alloy and/or with a coating of a different second metal alloy) have different materials and/or surface coatings. Two or three further contact pins 45 follow this contact pin 45 for earthing. While the contact pin 45 for earthing (earthing pin 53) as well as the pin-shaped contact plug elements 11 with rounded free end have a preferably constant pin diameter, the remaining contact pins 45 (highlighted by circles in FIG. 5 for clarification), starting from the plug-in connection module 12, initially have a constant pin diameter as with the contact pin 45 for earthing, which changes in a stepped manner to a diameter that is at least 20% smaller, which preferably continues constantly in the axial direction up to the free end (apart from the rounding of the free end). The latter section is so long that when connecting, only the section of the contact pin 45 with the smaller diameter penetrates the contact socket element 5 and produces the touching contact.

FIG. 5 also shows guide openings 51, which enable the guiding and locking devices 27 (see FIG. 1) to penetrate into the underside of the accessory container 10 and in this way both receive it and, if necessary, lock it by means of the undercuts 28. Feet 52, which are distributed on the edge of the underside of the accessory container 10 in the circumferential direction, ensure a stable placement on the base unit 1. Vibrations during food preparation could thus be partially absorbed and reduced, so that wear of the contact plug elements 11 and/or the contact socket elements 5 is reduced and a particularly reliable transmission of, in particular, digital signal data over a provided service life of the base unit 1 is enabled. In particular, the feet 52 are made of rubber-elastic material.

### LIST OF REFERENCE SIGNS

1 base unit
2 control
3 receiving device
4 receiving-side plug-in connection unit
5 contact socket element
6 receiving-side plug-in connection module
7 hollow body
8 axial play
9 radial play
10 accessory container
11 contact plug element
12 accessory-side plug-in connection module
13 signal processing unit
14 accessory-side plug-in connection unit
15 narrowed region
16 axial section
17 struts
18 axial direction
19 radial direction
20 food
21 cable
22 fastening unit
23 housing section
24 insertion opening
25 user interface
26 rubber cover
27 guiding and locking device
28 undercut
29 mixing or cutting tool
30 electric motor
31 mechanical interface
32 heating element
33 temperature sensor
34 container
35 Hall sensor
36 cover
37 reference body
38 metal plate
39 elongated hole
40 conical mouth
41 lower housing module part
42 upper housing module part
43 resilient clip
44 contact arms
45 contact pin
46 angular distance
47 lower stop surface
48 upper stop surface
49 extension region
50 recess
51 guide openings
52 feet
53 earthing pin

1. A base unit for a food processor for preparing a food, wherein the base unit comprises
a control and a receiving device for receiving and electrically connecting an interchangeable accessory container,
wherein the receiving device comprises at least one receiving-side plug-in connection unit for the electrical connection, and
wherein the receiving-side plug-in connection unit is at least partially movable in the mounted state in such a way that at least a part of the receiving-side plug-in connection unit is able to move with an accessory container when the accessory container is electrically connected to the receiving device via the receiving-side plug-in connection unit.

2. The base unit of claim 1, wherein the at least one receiving-side plug-in connection unit has a contact plug element or a contact socket element which can move with an accessory container when the accessory container is electrically connected to the receiving device via the receiving-side plug-in connection unit.

3. The base unit of claim 1, wherein the receiving-side plug-in connection unit is such that the at least one part of the receiving-side plug-in connection unit is movable and its axial mobility is limited by an axial play, so that the at least one part of the receiving-side plug-in connection unit can move axially with an accessory container in the extent of the axial play when the accessory container is electrically connected to the receiving device via the receiving-side plug-in connection unit.

4. The base unit of claim 1, wherein the axial play is at least 0.4 mm.

5. The base unit of claim 3, wherein the axial play is at most 1 mm.

6. The base unit of claim 1, wherein the receiving-side plug-in connection unit is such that there is no radial play in the connected state.

7. The base unit of claim 3, wherein the axial play in the connected state is greater than the radial play.

8. The base unit of claim 2, wherein the at least one movable part of the receiving-side plug-in connection unit is the contact plug element or the contact socket element.

9. The base unit of claim 1, wherein the base unit is configured in such a way that an analogue or digital signal is transmitted via the receiving-side plug-in connection unit in the connected state and/or a connected accessory container can be supplied with electrical energy.

10. The base unit of claim 9, wherein the base unit is configured such that a digital signal is transmitted and a connected accessory container is supplied with electrical energy via only one receiving-side plug-in connection unit in the connected state.

11. The base unit of claim 2, wherein the receiving-side plug-in connection unit is configured such that when an accessory container is being connected to the receiving device, the contact plug element is inserted axially into the contact socket element and/or the contact socket element expands elastically in a radial direction, which is orientated transversely to the axial direction, in order to receive the contact plug element and produce a touching contact for the electrical connection of the base unit to an accessory container.

12. The base unit of claim 2, wherein the receiving-side plug-in connection unit has the contact socket element, wherein the contact socket element has a C-shape when viewed in cross-section.

13. The base unit of claim 2, wherein the receiving-side plug-in connection unit has the contact socket element, and wherein the contact socket element has an axial through-opening with a narrowed region.

14. The base unit of claim 2, wherein the receiving-side plug-in connection unit has the contact socket element, wherein a cable is fastened to the contact socket element and wherein the contact socket element has a resilient fastening device for the cable.

15. An accessory container for the base unit of claim 1 for preparing a food, the accessory container comprising
a signal processing unit and
at least one accessory-side plug-in connection unit for an electrical connection to the receiving-side plug-in connection unit of the base unit (1), wherein, in the connected state, at least a part of the accessory-side plug-in connection unit can move with a part of the receiving-side plug-in connection unit when the accessory container is electrically connected to the receiving device.

16. The base unit of claim 3, wherein the axial play in the non-connected state is less than the radial play.

17. The base unit of claim 6, wherein the receiving-side plug-in connection unit is such that radial movement of at least part of the receiving-side plug-in connection unit is only possible by elastic deformation of the movable part of the receiving-side plug-in connection unit.

18. The base unit of claim 11, wherein the contact socket element is guided axially in an axially extending hollow body which is mounted in the receiving-side plug-in connection unit.

19. The base unit of claim 11, wherein the receiving-side plug-in connection unit has the contact socket element, wherein the contact socket element has a C-shape when viewed in cross-section and/or is guided axially in an axially extending hollow body which is mounted in the receiving-side plug-in connection unit.

20. The base unit of claim 13, wherein the contact socket element is formed from a plurality of elastically deformable struts at least in an axial section.
